(19) United States
(12) Patent Application Publication
(10) Pub. No.: US 2024/0041132 A1
(43) Pub. Date: Feb. 8, 2024

(54) Aerosol Generation Device Comprising a Non-Electrically Conductive Touch Panel and Associated Controlling Method

(71) Applicant: JT International SA, Geneva (CH)

(72) Inventors: Olayiwola Olamiposi Popoola, Walton-on-Thames (GB); Kyle Adair, Lisburn (GB); Peter Loveday, Surrey (GB)

(73) Assignee: JT International SA, Geneva (CH)

(21) Appl. No.: 18/277,139

(22) PCT Filed: Feb. 14, 2022
(86) PCT No.: PCT/EP2022/053460

§ 371 Date: Aug. 14, 2023

(30) Foreign Application Priority Data
Feb. 15, 2021 (EP) 21157057.7

(51) Int. Cl. A24F 40/60; A24F 40/51; A24F 40/53

(52) U.S. Cl. CPC A24F 40/60; A24F 40/51; A24F 40/53; G06F 3/044

(57) ABSTRACT

The present disclosure concerns an aerosol generation device including a housing having a non-electrically conductive touch panel arranged on an external surface and a plurality of touch sensors, each touch sensor being associated to an operational function carried out by a controller and configured to be activated further to a user interaction with the touch sensor based on an activation sensitivity of this touch sensor.

The activation sensitivity of each touch sensor is based on the operational function associated to the touch sensor, at least two touch sensors having different activation sensitivities.

### FIELD OF THE INVENTION

The present invention concerns an aerosol generation device comprising a non-electrically conductive touch panel.

The present invention also concerns a controlling method of such an aerosol generation device.

### BACKGROUND OF THE INVENTION

Different types of aerosol generation devices are already known in the art. Generally, such devices comprise a storage portion for storing a vaporizable material, which can comprise for example a liquid or a solid. A heating system is formed of one or more electrically activated resistive heating elements arranged to heat said vaporizable material to generate the aerosol. The aerosol is released into a flow path extending between an inlet and outlet of the device. The outlet may be arranged as a mouthpiece, through which a user inhales for delivery of the aerosol.

In some aerosol generation devices, the vaporizable material is stored in a removable cartridge. Thus, when the vaporizable material is consumed, the cartridge can be easily removed and replaced. In order to attach the removable cartridge to the device body, a screw-threaded connection can for example be used.

The heating system of the known aerosol generation devices is usually controlled by a controller. The operation of the controller, such as ON/OFF switching or other more advanced input commands, is controlled by a user using buttons or any other control actuators arranged on the housing of the aerosol generation device. In some cases, these buttons or actuators can be formed by a touch panel including at least one touch sensor for carrying out at least the ON/OFF switching function of the controller. In case of multiple input commands, the touch panel can comprise several touch sensors, each sensor being associated to a predetermined input command.

However, the available area to receive such a touch panel on the housing of the aerosol generation device is usually very limited and limits significantly the dimensions of the touch panel. This means that in the case of multiple touch sensors, the separation between them is very small and leads to wrong sensor detection, co-coupling between adjacent sensors and noisy interface. For example, the average adult fingertip width is comprised between 16 mm and 25 mm while the dimensions of a typical touch sensor are usually less than 10 mm. This means that accuracy of detecting of the corresponding input commands is reduced due to noise produced by different touch sensors.

### SUMMARY OF THE INVENTION

One of the aims of the invention is to provide an aerosol generation device comprising a touch panel ensuring a very accurate detection of multiple input commands despite reduced dimensions of the panel.

For this purpose, the invention relates to an aerosol generation device comprising a housing defining an external surface and comprising a controller configured to control the operation of the aerosol generation device;
the housing further comprising a non-electrically conductive touch panel arranged on the external surface and comprising a plurality of touch sensors, each touch sensor being associated to an operational function carried out by the controller and configured to be activated further to a user interaction with this touch sensor basing on an activation sensitivity of this touch sensor;
the aerosol generation device being characterized in that the activation sensitivity of each touch sensor is based on the operational function associated to this touch sensor, at least two touch sensors having different activation sensitivities.

Provided with these features, the activation sensitivity of each touch sensor can be adjusted independently so as to provide better accuracy of its activation detection. For example, for some operational functions, the activation sensitivity can be set very high so as the corresponding touch sensor can be used as a proximity sensor and the user's fingers do not need even to touch the sensor to activate it. On the contrary, for some other operational functions, the activation sensitivity is set very law so as to oblige the user to touch very precisely the corresponding touch sensor in order to activate it. In the general case, according to the invention, it is possible to tune the activation sensitivity of each touch sensor in order to achieve an optimal result, basing on the operational function associated to this touch sensor. Thus, it is possible to arrange a greater number of touch sensors even in a touch panel having reduced dimensions.

According to some embodiments, the touch panel comprises a printed circuit board, a plurality of conductive pads arranged on the printed circuit board and a guard channel arranged on the printed circuit board at least partially around the conductive pads, each touch sensor being formed by a conductive pad and at least a part of the guard channel.

Thanks to these features, the sensitivity of a touch sensor can be expressed by capacitance change between the corresponding conductive pad and the guard channel.

According to some embodiments, the activation sensitivity of at least one touch sensor is determined by the distance between the corresponding conductive pad and the guard channel on the printed circuit board.

Thanks to these features, the activation sensitivity can be adjusted at least partially in a hardware level as the distance between the conductive pad and the guard channel is proportional to the sensitivity of the corresponding touch sensor. Particularly, a conductive pad can be arranged closer to the guard channel for reduced activation sensitivity and higher accuracy of the corresponding touch sensor and far from the guard channel for increased activation sensitivity and lower accuracy.

According to some embodiments, the activation sensitivity of at least one touch sensor is determined by the surface area of the corresponding conductive pad.

Thanks to these features, the activation sensitivity can be adjusted at least partially in a hardware level as the surface area of the conductive pad is proportional to the activation sensitivity of the corresponding touch sensor. Particularly, a larger surface area leads to a larger change in capacitance which means a higher activation sensitivity.

According to some embodiments, the activation sensitivity of at least one touch sensor is determined by the size of the corresponding conductive pad in comparison with the size of at least one conductive pad adjacent to said conductive pad.

Thanks to these features, the activation sensitivity can be adjusted at least partially in a hardware level as varying the size of the conductive pads in relation to each other can be used to tune the activation sensitivity of the corresponding touch sensors. For example, if a first conductive pad is larger than a second conductive part, it will be more sensitive (like having the ‘Enter’ key larger than other keys on a PC keyboard). Also, this technique can be used to simulate a greater distance between conductive pads. For example, if conductive pads 1 & 3 are a high sensitivity pads with conductive pads 2 and 4 being a low sensitivity pads then a finger placed across two adjacent pads will give priority to the higher sensitivity pad. Other configurations are possible.

According to some embodiments, the touch panel further comprises an output unit and for each conductive pad, a track arranged on the printed circuit board and connecting the corresponding conductive pad to the output unit.

According to some embodiments, the total surface area of each track is less than 30% of the surface area of the corresponding conductive pad, advantageously less than 20% of the surface area of the corresponding conductive pad, and preferably less than 10% of the surface area of the corresponding conductive pad.

Thanks to these features, it is possible to reduce the effects of capacitive co-coupling and noise on the sensor tracks. A higher ratio of sensor pad area to track area gives a more sensitive input.

According to some embodiments, the output unit is configured to detect activation of at least one touch sensor according to its activation sensitivity, generate a respective activation signal and transmit said activation signal to the controller.

Thanks to these features, the activation sensitivity can be fully determined on the hardware level.

According to some embodiments, the output unit is configured to detect capacitance change of at least one touch sensor and transmit said capacitance change to the controller.

Thanks to these features, the activation sensitivity can be at least partially determined in a software level.

According to some embodiments, the controller is further configured to analyze each received capacitance change and basing on this analysis, detect activation of the corresponding touch sensor according to its activation sensitivity.

According to some embodiments, the activation sensitivity of at least one touch sensor is determined dynamically by the controller basing on the operational function associated to this touch sensor.

Thanks to these features, the activation sensitivity of at least one touch sensor can be determined dynamically, for example basing on the vaping phase of the aerosol generation device, time of using it, manner of using, user settings, etc. Thus, it is possible to associate different operational functions to a same touch sensor.

According to some embodiments, the activation sensitivity of least one touch sensor is chosen to cause activation of this sensor further to a contactless user interaction with this sensor.

Thanks to these features, the touch sensor can be used as a proximity sensor and it can be arranged even in very limited surface areas.

According to some embodiments:
the touch panel extends according to an extension axis of the device;
the conductive pads are arranged along the extension axis; and
the guard channel is arranged on the periphery of the printed circuit board.

According to some embodiments, the length of the touch panel along the extension axis is less than 50 mm, advantageously less than 40 mm and preferably equal to 30 mm.

Thanks to these features, the touch panel may be arranged in a compact way on the housing of the aerosol generation device.

The present invention also concerns a controlling method, comprising the following steps:
determining an activation sensitivity for each touch sensor based on the operational function associated to this touch sensor;
setting different activation sensitivities for at least two touch sensors;
activating the operational function associated to a touch sensor further to a user interaction with this touch sensor, accordingly to the activation sensitivity of this touch sensor.

The invention and its advantages will be better understood upon reading the following description, which is given solely by way of non-limiting example and which is made with reference to the appended drawings, in which:

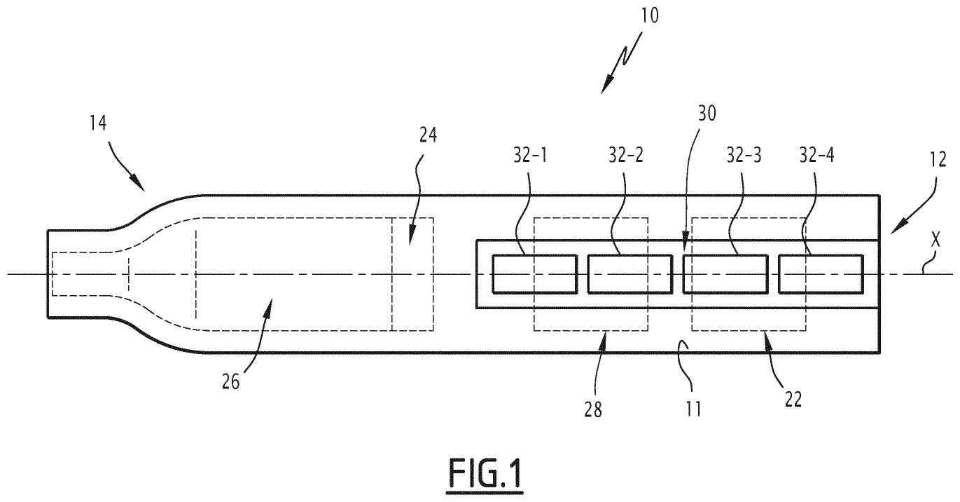

FIG. 1 is a schematic view of an aerosol generation device according to a first embodiment of the invention, the aerosol generation device comprising a touch panel;

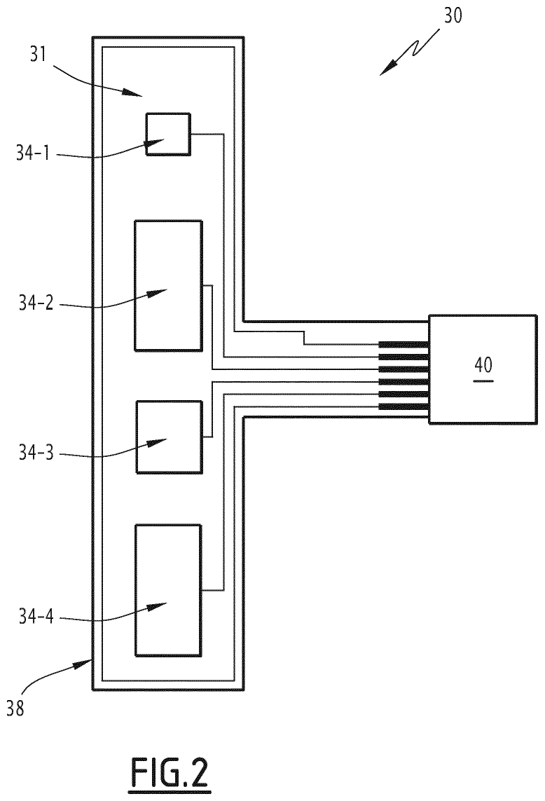

FIG. 2 is a schematic view of the touch panel of FIG. 1; and

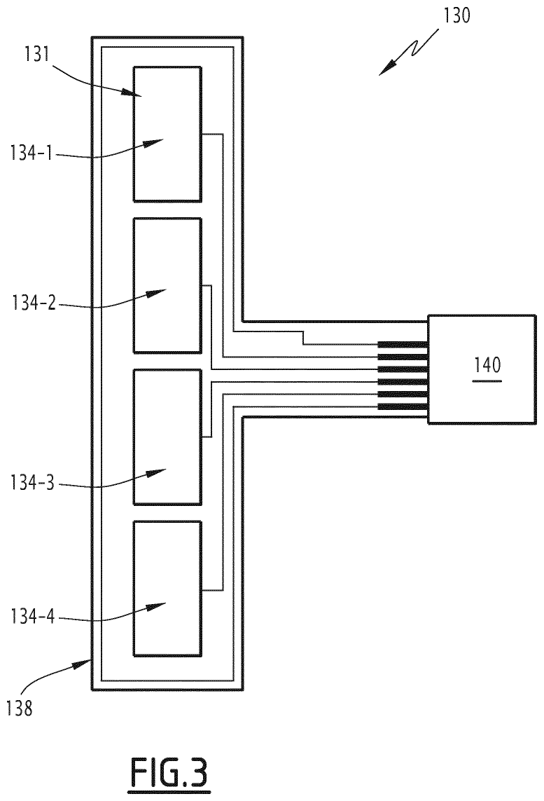

FIG. 3 is a schematic view of a touch panel of an aerosol generation device according to a second embodiment of the invention.

### DETAILED DESCRIPTION OF THE INVENTION

Before describing the invention, it is to be understood that it is not limited to the details of construction set forth in the following description. It will be apparent to those skilled in the art having the benefit of the present disclosure that the invention is capable of other embodiments and of being practiced or being carried out in various ways.

As used herein, the term “aerosol generation device” or “device” may include a vaping device to deliver an aerosol to a user, including an aerosol for vaping, by means of aerosol generating unit (e.g. an aerosol generating element which generates vapor which condenses into an aerosol before delivery to an outlet of the device at, for example, a mouthpiece, for inhalation by a user). The device may be portable. “Portable” may refer to the device being for use when held by a user. The device may be adapted to generate a variable amount of aerosol, e.g. by activating a heater system for a variable amount of time (as opposed to a metered dose of aerosol), which can be controlled by a trigger. The trigger may be user activated, such as a vaping button and/or inhalation sensor. The inhalation sensor may be sensitive to the strength of inhalation as well as the duration of inhalation to enable a variable amount of vapour to be provided (so as to mimic the effect of smoking a conventional combustible smoking article such as a cigarette, cigar or pipe, etc.). The device may include a temperature regulation control to drive the temperature of the heater and/or the heated aerosol generating substance (aerosol pre-cursor) to a specified target temperature and thereafter to maintain the temperature at the target temperature that enables efficient generation of aerosol.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

As used herein, the term “vaporizable material” or “precursor” or “aerosol forming substance” or “substance” is used to designate any material that is vaporizable in air to form aerosol. Vaporization is generally obtained by a temperature increase up to the boiling point of the vaporization material, such as at a temperature less than 400° C., preferably up to 350° C. The vaporizable material may, for example, comprise or consist of an aerosol-generating liquid, gel, wax, foam or the like, an aerosol-generating solid that may be in the form of a rod, which contains processed tobacco material, a crimped sheet or oriented strips of reconstituted tobacco (RTB), or any combination of these. The vaporizable material may comprise one or more of: nicotine, caffeine or other active components. The active component may be carried with a carrier, which may be a liquid. The carrier may include propylene glycol or glycerin. A flavouring may also be present. The flavouring may include Ethylvanillin (vanilla), menthol, Isoamyl acetate (banana oil) or similar.

As used herein, the term “external device” may refer to a device, which is able to establish a wireless data connection with the aerosol generation device as it is explained in the specification. Such an external device may be a mobile device like a mobile phone for example. Additionally, such an external device may be a smart device able to process at least some data received from the aerosol generation device or intended to be transmitted to the aerosol generation device. Such a smart device can be a smartphone, a smartwatch, a tablet computer, a laptop, a desktop computer or any other smart object implemented for example according to the IoT (“Internet of things”) technology. Such a smart device can be also another aerosol generation device similar to said aerosol generation device.

As used herein, the term “capacitance change” is used to designate any value that can be measured between different states of a capacitive touch sensor. Such capacitance change may occur further to interaction with the touch sensor of a conductive material or a dielectric material having a dielectric value different from the dielectric value of air. Particularly, capacitance change may occur further to interaction of a user finger with the touch sensor. Such interaction can comprise physical touching of the touch sensor by the user finger or approaching the user finger to the touch sensor without touching it. In this last case, capacitance change may occur when the user finger is sufficiently close to the touch sensor.

As used herein, the term “activation sensitivity” is used to designate a threshold of capacitance change of a single touch sensor above which the sensor is considered as activated. According to different embodiments of the invention, the activation sensitivity may be set in a hardware way and/or software way. In this last case, the activation sensitivity may be dynamically changed, depending for example on the operational function associated to the corresponding touch sensor.

### First Embodiment of the Invention

Referring to FIG. 1, an aerosol generation device 10 according to the invention comprises a housing 11 extending between a hold end 12 and a mouthpiece end 14, according to an extension axis X.

The housing 11 defines an internal surface delimiting an interior part of the aerosol generation device 10 comprising a power block 22 designed to power the device 10, a heating system 24 powered by the power block 22, a payload compartment 26 in contact with the heating system 24 and a controller 28 controlling the operation of the device. The interior part of the aerosol generation device 10 may further comprise other internal components performing different functionalities of the device 10 known per se. For example, the housing 11 of the aerosol generation device 10 may further comprises a pressure sensor, an inertial sensor, a communication module, etc.

The housing 11 further defines an external surface opposite to its internal surface. On this external surface, the housing 11 comprises a non-electrically conductive touch panel 30 designed to generate input commands to the controller 28.

It should be noted that FIG. 1 presents only a schematic diagram of different components of the aerosol generation device 10 and does not necessarily show the real physical arrangement and dimensions of these components. Particularly, such an arrangement can be chosen according to the design of the aerosol generation device 10 and technical features of its components.

The power block 22 comprises for example a battery and a battery charger. The battery is for example a known battery designed to be charged using the power supply furnished by an external source and to provide a direct current of a predetermined voltage. The battery charger is able to connect the battery to the external source and comprises for this purpose a power connector (like for example a mini-USB connector) or wireless charging connector. The battery charger is also able to control the power delivered from the external source to the battery according for example a predetermined charging profile. Such a charging profile can for example define a charging voltage of the battery depending on its level of charge.

The payload compartment 26 is designed to store the vaporizable material used to generate aerosol. Particularly, based on the nature of the vaporizable material, the payload compartment 26 can be designed to store the precursor in a liquid and/or solid form. The payload compartment 26 can be fixed in respect with the housing 11 of the aerosol generation device 10 or removable from it. In the first case, the payload compartment 26 can be refilled with the vaporizable material. In the second case, the payload compartment 26 can present a replaceable cartridge (e.g., a pod or capsule containing e-liquid) or consumable (e.g., a tobacco rod) that can be removed and replaced by another one when the vaporizable material is no longer available. In some embodiments, the replaceable cartridge can be also refilled with the vaporizable material.

The heating system 24 comprises a heater in contact with the payload compartment 26 or integrated partially into this compartment 26. Powered by the power block 22 and controlled by the controller 28, the heater is able to heat the vaporizable material comprised in the payload compartment 26 to generate aerosol. In some embodiments, the heater operation may be controlled by the controller 28 according to its temperature. In this case, the heater temperature can be determined by the controller 28 using resistance measurements of the heater or temperature measurements acquired by a heating temperature sensor arranged in the heating system 24.

The controller 28 is formed for example by a microcontroller and is able to control the operation of the aerosol generation device 10. Particularly, the controller 28 is able to carry out at least one operational function of the device 10, basing on input commands. For example, said operational function can consist in controlling the operation of the heating system 24 by controlling the powering of this system 24 by the power block 22. In this case, the input commands may consists in “ON/OFF” command, temperature regulating command, hold command, etc. According to additional examples, an operation function can consists in controlling the quantity and/or the vapour of the delivered aerosol, a communication capacity of the device to communicate with an external device, a measuring capacity of the device, etc. In these cases, different input commands depending on the nature of the operation function can be associated to such a function. For example, for the delivered aerosol quantity controlling function, an input command specifying such a quantity may be associated. For the communication capacity, an input command initiating pairing with an external device may be associated. For the measuring capacity, an input command consisting in initiating of measuring of a predetermined value may be associated. Of course, numerous other examples of operational functions and associated input commands are possible.

The touch panel 30 is for example arranged in an opening formed on the external surface of the housing 11, for example adjacent to the hold end 12 of the device 10. As it is shown on FIG. 1, the touch panel 30 extends according to the extension axis X. According to different examples of the invention, the length of the touch panel 30 along the extension axis X is less than 50 mm, advantageously less than 40 mm and preferably equal to 30 mm. Thus, its length may be less than a half of the length of the housing 11 according to the extension axis X, advantageously less than one-third or one-quarter of the length of the housing 11 according to the extension axis X.

The touch panel 30 may for example comprise a printed circuit board 31 (shown on FIG. 2), also called PCB, and a protecting structure (not-shown) covering the printed circuit board 31. The printed circuit board may be flexible and made for example at least partially from polyimide. According to another example, the printed circuit board is rigid and made for example from FR4. The protecting structure may be formed for example by a glass or any other dielectric material. The protecting structure can be transparent or opaque. It can further comprise different graphic and/or alphanumerical symbols indicating at least some touch sensors explained in further detail below. In some embodiments, such symbols can be displayed on a display area superposed with the protecting structure or arranged away from the touch panel 30. The display area can eventually modify the symbols according to different cases of using of the aerosol generation device 10.

The touch panel 30 further comprises a plurality of touch sensors 32-1, . . . , 32-N. In the example of FIG. 1, the number N is equal to 4. Each touch sensor 32-1, . . . , 32-4 is associated to at least one operational function carried out by the controller 28. Particularly, each single touch sensor 32-1, . . . , 32-4 or a group of touch sensors 32-1, . . . , 32-4 is able to cause generation of an input command associated to the corresponding operational function. For example, a touch sensor can form an “ON/OFF” button able to cause generation of an “ON/OFF” command or “+” button able to cause generation of a temperature increasing command. According to another example, a group of touch sensors 32-1, . . . , 32-4 can cause generation of a predetermined input command further for example to their simultaneous activation (i.e. multi-touch action), consecutive activation (i.e. sliding action) or activation according to a predetermined pattern (i.e. pattern action).

The association of each touch sensor 32-1, . . . , 32-4 to an operational function may be done permanently or temporary. In the first case, the association does not change while using the aerosol generation device 10, like it can be for example the case of the “ON/OFF” button. In the second case, the association can be modified depending on using of the aerosol generation device 10. For example, in the case of “+” button, the corresponding touch sensor may be associated to the heating controlling capacity while the device 10 is being used to generate aerosol and to the communication capacity while the device 10 is being connected to an external device.

The internal structure of the touch panel 30 will now be explained in further detail in reference to FIG. 2. Thus, as it is shown on this FIG. 2, the touch panel 30 comprises a conductive pad 34-1, . . . , 34-4 arranged on the printed circuit board 31 for each touch sensor 32-1, . . . , 32-4, a guard channel 38 arranged on the printed circuit board 31 at least partially around the conductive pads 34-1, . . . , 34-4, and an output unit 40. Each touch sensor 32-1, . . . , 32-4 is formed by the corresponding conductive pad 34-1, . . . , 34-4 and at least a part of the guard channel 38. The conductive pads 34-1, . . . , 34-4 and the guard channel 38 are made from a conductive material like copper or silver that could be any thickness like for example 0.5, 0.75, 1 or 2 oz (respectfully 17 μm, 26 μm, 35 μm or 70 μm).

The guard channel 38 is for example arranged at the peripheral area of the printed circuit board 31 and comprises two ends connected to the output unit 40. Each conductive pad 34-1, . . . , 34-4 is arranged in the interior area of printed circuit board 31 and is surrounded at least partially by at least a part of the guard channel 38. Thus, each conductive pad 34-1, . . . , 34-4 forms a capacitance of a known value with the corresponding portion of the guard channel 38. Each conductive pad 34-1, . . . , 34-4 is connected to the output unit 40 by a track arranged on the printed circuit board 31. The tracks can be made from the same conductive material as the pads 34-1, . . . , 34-4 and the guard channel 38. Advantageously according to the invention, the total surface area of each track is less than 30% of the surface area of the corresponding conductive pad 34-1, . . . , 34-4, advantageously less than 20% of the surface area of the corresponding conductive pad 34-1, . . . , 34-4, and preferably less than 10% of the surface area of the corresponding conductive pad 34-1, . . . , 34-4.

According to the first embodiment of the invention, the activation sensitivity of each touch sensor 32-1, . . . , 32-4 is defined on the hardware level, by the dimensions of the corresponding touch pads 34-1, . . . , 34-4 and/or respective arrangements of the corresponding touch pads 34-1, . . . , 34-4 and/or arrangements of the corresponding touch pads 34-1, . . . , 34-4 in respect with the guard channel 38.

Particularly, according to an example, the activation sensitivity of at least one touch sensor 32-1, . . . , 32-4 is determined by the distance between the corresponding conductive pad 34-1, . . . , 34-4 and the guard channel 38 on the printed circuit board 31. In this case, the distance between the conductive pad 34-1, . . . , 34-4 and the guard channel 38 is proportional to the sensitivity of the corresponding touch sensor 32-1, . . . , 32-4. Particularly, a conductive pad 34-1, . . . , 34-4 can be arranged closer to the guard channel 38 for reduced activation sensitivity and higher accuracy of the corresponding touch sensor and far from the guard channel 38 for increased activation sensitivity and lower accuracy. In the example of FIG. 2, the conductive pads 34-2, 34-3 and 34-4 are arranged closer to the guard channel 38 than the conductive pad 34-1 and thus, the touch sensors 32-2, 32-4 and 32-4 have reduced activation sensitivity, according to at least this criterion, in comparison with the activation sensitivity of the touch sensor 32-1.

According to a complementary example, the activation sensitivity of at least one touch sensor 32-1, . . . , 32-4 is determined by the surface area of the corresponding conductive pad 34-1, . . . , 34-4. In this case, the surface area of the conductive pad 34-1, . . . , 34-4 is proportional to the sensitivity of the corresponding touch sensor 32-1, . . . , 32-4. Particularly, a larger surface area leads to a larger change in capacitance which means a higher activation sensitivity. In the example of FIG. 2, the conductive pads 34-2 and 34-4 have larger surface areas in comparison with the surface areas of the conductive pads 34-1 and 34-3. Thus, the touch sensors 32-2 and 32-4 can define a greater activation sensitivity, at least according to this criterion, than the touch sensors 32-1 and 32-3.

According to a complementary example, the activation sensitivity of at least one touch sensor 32-1, . . . , 32-4 is determined by the size of the corresponding conductive pad 34-1, . . . , 34-4 in comparison with the size of at least one conductive pad 34-1, . . . , 34-4 adjacent to said conductive pad 34-1, . . . , 34-4. Thus, in the example of FIG. 2, the touch sensor 32-2 corresponding to the conductive pad 34-2 having greater dimensions in comparison with the adjacent conductive pads 34-1 and 34-3 can define, at least according to this criterion, a greater activation sensitivity than the activation sensitivities of the touch sensors 32-1 and 32-3.

Of course, all of the previously mentioned techniques used to define the activation sensitivity of a touch sensor can be combined between them in any suitable manner in order to obtain an optimal result.

According to the first embodiment of the invention, the output unit 40 is able to detect activation of each touch sensor 32-1, . . . , 32-4 by detecting a capacitance change between the corresponding conductive pad 34-1, . . . , 34-4 and the guard channel 38, greater than a predetermined value. Upon detection of activation of a touch sensor 32-1, . . . , 32-4, the output unit 40 is able to generate a corresponding activation signal and transmit it to the controller 28. Upon reception such an activation signal, the controller 28 is able to interpret this signal as an input command of the operational function associated to the corresponding touch sensor 32-1, . . . , 32-4. In some cases, the controller 28 is able to interpret a plurality of signals transmitted by the output unit 40 as a unique input command of the corresponding operational function. This can be the case when several touch sensors 32-1, . . . , 32-4 are required to be activated by the user simultaneously or consecutively, as for example a sliding action or any other predetermined activation pattern.

A controlling method of the aerosol generation device 10 according to the first embodiment of the invention will now be explained.

According to the first embodiment of the invention, an initial step of this method is carried out at the conception stage of the device. Particularly, during this step, an activation sensitivity is chosen for each touch sensor 32-1, . . . , 32-4 basing on the operational function associated to it. As previously described, each activation sensitivity may be determined by the arrangement and/or dimensions of the corresponding conductive pad 34-1, . . . , 34-4. Different activation sensitivities are set for at least two touch sensors

The next step of the controlling method is carried out by the controller 28 while operating of the aerosol generation device 10. Particularly, during this step, a user interacts with the touch panel 30. The output unit 40 detects activation of at least one touch sensor 32-1, . . . , 32-4 according to its activation sensitivity. Then, the output unit 40 transmits an activation signal to the controller 30 which interprets this signal as an input command and activates the corresponding operational function according to this input command.

### Second Embodiment of the Invention

An aerosol generation device according to a second embodiment of the invention is similar to the aerosol generation device 10 described above. Thus, the common components of these devices will not be explained below.

The aerosol generation device according to the second embodiment of the invention comprises a touch panel 130 defining a plurality of touch sensors and having an internal structure which can be different from the internal structure of the touch panel 30 explained above. As in the previous case, the number of the touch sensors may be equal for example to 4.

Particularly, in reference to FIG. 3, the touch panel 130 comprises a conductive pad 134-1, . . . , 134-4 arranged on the printed circuit board 131 for each touch sensor, a guard channel 138 arranged on the printed circuit board 131 at least partially around the conductive pads 134-1, . . . , 134-4, and an output unit 140. The printed circuit board 131 and the guard channel 138 are similar to those explained above.

Contrary to the previous case, the conductive pads 134-1, . . . , 134-4 according to the second embodiment of the invention may have substantially the same dimensions and can be arranged with the same distance in respect with the guard channel 138. In this case, different activation sensitivities of the corresponding touch sensors can be defined using the output unit 140 or the control unit 28.

According to one example of this embodiment, the activation sensitivities of the touch sensors are defined on the hardware level, for example by the output unit 140. In this case, each activation sensitivity can be defined basing on the corresponding operational function for example at the conception stage of the device, and stored by the output unit 140 independently for each conductive pad 134-1, . . . , 134-4. Thus, the output unit 140 is able to measure capacitance change between each conductive pad 134-1, . . . , 134-4 and the guard channel 138 and if this change is greater than the stored activation sensitivity for the corresponding conductive pad 134-1, . . . , 134-4, generate an activation signal for the controller 28 of the device, like in the previous case.

According to another example, the activation sensitivities of the touch sensors are defined on the software level, for example by the controller 28. These activation sensitivities can be for example stored by the controller 28 in a programmable way or can be modified by the user or dynamically by the controller 28 according for the example to different cases of using of the device. For example, different activation sensitivities can be associated to a same touch sensor depending if the device 10 is being used for generate vapour or for transmit data to an external device. In this case, the output unit 140 is able to measure capacitance change between each conductive pad 134-1, . . . , 134-4 and the guard channel 138 and transmit this change to the controller 28 using for example an appropriate data bus. This value can be transmitted together with an identifier of the corresponding touch sensor. Thus, the controller 28 is configured to analyze this data and basing on this analysis, detect activation of the corresponding touch sensor according to its activation sensitivity.

The controlling method of the aerosol generation device according to the second embodiment of the invention is similar to the controlling method of the aerosol generation device according to the first embodiment. However, in the second embodiment, the initial step of determining the activation sensitivities can be carried out either at the conception stage of the aerosol generation device and during its operation. Additionally, during the following step of activating operational functions according to the second embodiment, the output unit 140 may transmit to the controller measured capacitance changes which are then analysed by the controller 28.

### Other Embodiments of the Invention

Other embodiments of the invention are still possible. For example, it is possible to combine hardware and software determination of the activation sensitivities, as explained above. For example, the activation sensitivities can be partially determined by the arrangements of the corresponding conductive pads and/or their dimensions, and partially on the software level, for example by the controller of the device.

1. An aerosol generation device comprising a housing defining an external surface and comprising a controller configured to control the operation of the aerosol generation device;
the housing further comprising a non-electrically conductive touch panel arranged on the external surface and comprising a plurality of touch sensors, each touch sensor being associated to an operational function carried out by the controller and configured to be activated further to a user interaction with that touch sensor based on an activation sensitivity of that touch sensor;
wherein activation sensitivity of each touch sensor is based on the operational function associated to that touch sensor, and wherein at least two touch sensors have different activation sensitivities.

2. The aerosol generation device according to claim 1, wherein the touch panel comprises a printed circuit board, a plurality of conductive pads arranged on the printed circuit board and a guard channel arranged on the printed circuit board at least partially around the conductive pads, each touch sensor being formed by a conductive pad and at least a part of the guard channel.

3. The aerosol generation device according to claim 2, wherein activation sensitivity of at least one touch sensor is determined by a distance between a corresponding conductive pad and the guard channel on the printed circuit board.

4. The aerosol generation device according to claim 2, wherein the activation sensitivity of at least one touch sensor is determined by a surface area of the corresponding conductive pad.

5. The aerosol generation device according to claim 2, wherein the activation sensitivity of at least one touch sensor is determined by a size of the corresponding conductive pad in comparison with a size of at least one conductive pad adjacent to said conductive pad.

6. The aerosol generation device according to claim 2, wherein the touch panel further comprises an output unit and for each conductive pad, a track arranged on the printed circuit board and connecting the corresponding conductive pad to the output unit.

7. The aerosol generation device according to claim 6, wherein a total surface area of each track is less than 30% of a surface area of the corresponding conductive pad.

8. The aerosol generation device according to claim 6, wherein the output unit is configured to detect activation of at least one touch sensor according to its activation sensitivity, generate a respective activation signal, and transmit said activation signal to the controller.

9. The aerosol generation device according to claim 6, wherein the output unit is configured to detect capacitance change of at least one touch sensor and transmit said capacitance change to the controller.

10. The aerosol generation device according to claim 9, wherein the controller is further configured to analyze each received capacitance change and based on the analysis, detect activation of the corresponding touch sensor according to its activation sensitivity.

11. The aerosol generation device according to claim 10, wherein the activation sensitivity of at least one touch sensor is determined dynamically by the controller based on the operational function associated to the touch sensor.

12. The aerosol generation device according to claim 1, wherein a activation sensitivity of least one touch sensor is chosen to cause activation of the sensor further to a contactless user interaction with the sensor.

13. The aerosol generation device according to claim 2, wherein:
the touch panel extends according to an extension axis of the device;
the conductive pads are arranged along the extension axis; and
the guard channel is arranged on a periphery of the printed circuit board.

14. The aerosol generation device according to claim 13, wherein a length of the touch panel along the extension axis is less than 50 mm.

15. A controlling method of an aerosol generation device according to claim 1, comprising the following steps:
determining the activation sensitivity for each touch sensor based on the operational function associated to the touch sensor;
setting different activation sensitivities for at least two of the touch sensors;
activating the operational function associated to a touch sensor further to a user interaction with the touch sensor according to the activation sensitivity of the touch sensor.

16. The aerosol generation device according to claim 7, wherein the total surface area of each track is less than 10% of the surface area of the corresponding conductive pad.

17. The aerosol generation device according to claim 14, wherein the length of the touch panel along the extension axis is less than 40 mm.

18. The aerosol generation device according to claim 17, wherein the length of the touch panel along the extensions axis is equal to approximately 30 mm.
